(19) United States
(12) Patent Application Publication
(10) Pub. No.: US 2021/0355716 A1
(43) Pub. Date: Nov. 18, 2021

(54) CLOSURE LATCH ASSEMBLY WITH POWER RELEASE MECHANISM HAVING OPTIMIZED OPENING FUNCTIONALITY AND REDUCED RESET NOISE

(71) Applicant: MAGNA CLOSURES INC., Newmarket (CA)

(72) Inventors: Francesco CUMBO, Pisa (IT); Luca BIGAZZI, Ponsacco (IT)

(21) Appl. No.: 17/235,901

(22) Filed: Apr. 20, 2021

Related U.S. Application Data
(60) Provisional application No. 63/026,691, filed on May 18, 2020.

(51) Int. Cl. E05B 81/16; E05B 83/36; E05B 81/30; E05B 81/34; E05B 81/64; E05B 81/06

(52) U.S. Cl. CPC E05B 81/16; E05B 83/36; E05B 81/06; E05B 81/34; E05B 81/64; E05B 81/30

(57) ABSTRACT

A power latch assembly for a vehicle door and method of construction thereof is provided. The power latch assembly includes a pawl configured for movement between a ratchet holding position whereat the pawl maintains a ratchet in a striker capture position and a ratchet releasing position whereat the pawl releases the ratchet to a striker release position. A pawl release lever moves the pawl between the ratchet holding position and the ratchet releasing position. A powered actuator is energizable to control movement of the pawl release lever, wherein upon the pawl reaching the ratchet releasing position, the powered actuator is automatically de-energized without a hard stop feature.

### CROSS-REFERENCE TO RELATED APPLICATION

This application claims the benefit of U.S. Provisional Application Ser. No. 63/026,691, filed May 18, 2020, which is incorporated herein by reference in its entirety.

### FIELD

The present disclosure relates generally to automotive door latches, and more particularly, to a power door latch assembly equipped with a power release/power reset motor control to regulate energization and de-energization of a power motor.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed, lock the door in its closed position, and unlatch and release the door to permit subsequent movement of the door to its open position. As is also well known, the latch assembly is configured to include a latch mechanism for latching the door, a lock mechanism interacting with the latch mechanism for locking the door, and a release mechanism interacting with the lock mechanism for unlocking and unlatching the door. These mechanisms can be manually-operated via an inside and outside door handle and/or power-operated to provide the desired level of standard features. In known latch assemblies, if the latch mechanism is both power and mechanically actuatable, the ability to utilize power and mechanical release and reset mechanisms continuously coexist, such that the user can use either the power or mechanical mechanism at any time to actuate the latch mechanism. Accordingly, the latch mechanism can be unlatched via power or mechanical actuation of the inside and outside doors handle by the user at any time.

During powered actuation of latch mechanism, both during release and reset operations, it is known to regulate the powered movement of a gear(s) driven by the motor via hard stop features and by sensors configured in direct communication with a driven gear. Such hard stop features can be formed integrally with a housing of the latch mechanism, fixed thereto, or to some other latch component. Upon the gear or feature associate therewith, including a lever associated with latch mechanism, coming into direct physical contact with the hard stop feature, the motor is typically signaled and de-energized. During impact of the gear or feature with the hard stop feature, undesirable noise is generated. Further yet, the energization/de-energization of the motor can be facilitated via detection of the position of the driven gear with the sensor. However, upon de-energizing the motor, the driven gear can continue to rotate via inertia, and thus, the position of driven gear relative to the sensor in communication therewith can be other than desired.

Thus, there remains a need to develop alternative arrangements for latch mechanisms for use in vehicular side door latches which regulate the energization and de-energization of a powered motor without generating noise from stop features associated therewith and also that results in accurate, repeatable and reliable positioning of the driven gear and associated latch components.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

It is another object of the present disclosure to provide a power latch assembly for motor vehicle closure applications that has a motor that is de-energized without need of hard stop features, thereby resulting in reduced noise operation.

It is another object of the present disclosure to provide a power latch assembly for motor vehicle closure applications that results in accurate, repeatable and reliable positioning of a driven gear and associated latch components.

In accordance with the above objects, one aspect of the disclosure provides a power latch assembly for a vehicle door including a ratchet configured for movement between striker capture and striker release positions and being biased toward the striker release position. The power latch assembly includes a pawl configured for movement between a ratchet holding position whereat the pawl maintains the ratchet in the striker capture position and a ratchet releasing position whereat the pawl releases the ratchet to the striker release position. A pawl release lever is configured to selectively move the pawl between the ratchet holding position and the ratchet releasing position. A powered actuator is energizable to control movement of the pawl release lever to move the pawl from the ratchet holding position to the ratchet releasing position, wherein upon the pawl reaching the ratchet releasing position, the powered actuator is automatically de-energized without a hard stop feature.

According to another aspect of the present disclosure, the power latch assembly further includes an activation/deactivation device configured in operable communication with the pawl release lever. The activation/deactivation device is configured to be in an activated state while the pawl release lever is in a home position, whereat the power release actuator can be selectively energized. The activation/deactivation device is configured to be moved to a deactivated state in response to the pawl being moved to the ratchet releasing position, whereat the power release actuator is automatically de-energized, thereby negating the need for a hard stop feature to stop movement of latch components.

According to another aspect of the present disclosure, the power latch assembly further includes a drive gear driven by the power release actuator, with the drive gear being in meshed engagement with a driven gear having a release cam fixed thereto. The release cam is configured to engage a cam driving surface of the pawl release lever to move the pawl release lever between the home position and the pawl release position in response to the driven gear being driven from a driven gear home position by the drive gear. The release cam is configured for lost-motion movement with the pawl release lever after the pawl release lever reaches the pawl release position, thereby, in combination with the power release actuator being de-energized, negating the need for a hard stop feature to stop movement of latch components.

According to another aspect of the present disclosure, the release cam is configured to travel along a first radii of curvature relative to a rotational axis of the driven gear in response to movement of the driven gear. The pawl release lever has a lost-motion cam surface extending from the cam driving surface. The lost-motion cam surface has a second radii of curvature relative to the rotation axis, wherein the first radii of curvature is substantially the same as the second radii of curvature such that the release cam moves relative to the pawl release lever along the lost-motion cam surface.

According to another aspect of the present disclosure, the pawl release lever can remain stationary as the release cam moves along the lost-motion cam surface, thereby preventing the pawl release lever from moving beyond the pawl release position.

According to another aspect of the present disclosure, the activation/deactivation device can remain in the deactivated state when the pawl release lever is in the pawl release position.

According to another aspect of the present disclosure, the pawl release lever can be provided having a lug configured to trigger the activation/deactivation device to change the activation/deactivation device between the activated and deactivated states.

According to another aspect of the present disclosure, the lug can be configured to return into engagement with the activation/deactivation device to move the activation/deactivation device to the activated state as the pawl release lever returns toward the home position.

According to another aspect of the present disclosure, the power latch assembly can further include a magnet fixed to the pawl and a sensor configured in operable communication with the magnet to detect the position of the pawl, such as when the pawl is in the ratchet releasing position. The sensor is configured in operable communication with the power release actuator to automatically reverse the direction of movement of the power release actuator after detecting the pawl being in the ratchet release position to allow the pawl release lever to return to the home position.

According to another aspect of the present disclosure, the driven gear returns to the driven gear home position without use of a hard stop, thereby reducing the potential for the generation of noise.

According to another aspect of the present disclosure, the driven gear returns to the driven gear home position without use of a sensor detecting the position of the driven gear, thereby reducing complexity and cost.

According to another aspect of the present disclosure, the activation/deactivation device can be provided as one of a physically actuatable/deactuatable switch or proximity sensor configured to determine when the pawl release lever is in the home position and the pawl release position, wherein the activation/deactivation device is configured in operable communication with the power release actuator to allow the power release actuator to be energized when the pawl release lever is in the home position and to be automatically de-energized when the pawl release lever is moved to the pawl release position.

According to another aspect of the present disclosure, the activation/deactivation device can be configured in operable communication with the power release actuator via an electric control unit (ECU), wherein the ECU signals the power release actuator to automatically reverse the direction of movement of the power release actuator upon the pawl release lever reaching its pawl release position, thereby allowing the pawl release lever to return to its home position.

According to another aspect of the present disclosure, a sensor can be configured to detect when the pawl is in the ratchet releasing position, wherein the sensor is configured in operable communication with the power release actuator, such as via ECU, to automatically reverse the direction of movement of the power release actuator after detecting the pawl being moved to the ratchet release position, thereby allowing the pawl release lever to return to the home position.

According to another aspect of the present disclosure, a power latch assembly for a vehicle door includes a ratchet configured for movement between a striker capture position and a striker release position and being biased toward the striker release position. A pawl is configured for movement between a ratchet holding position, whereat the pawl maintains the ratchet in the striker capture position, and a ratchet releasing position, whereat the pawl releases the ratchet for movement of the ratchet to the striker release position. A pawl release lever is configured for movement between a home position and a pawl release position to selectively move the pawl from the ratchet holding position to the ratchet releasing position. A power release actuator is configured to move the pawl release lever between the home position and the pawl release position to move the pawl from the ratchet holding position to the ratchet releasing position. A drive gear is driven by the power release actuator, wherein the drive gear is configured in operable driving engagement with a driven gear having a release cam fixed thereto. The release cam is configured to engage a cam driving surface of the pawl release lever to move the pawl release lever between the home position and the pawl release position in response to the driven gear being driven from a driven gear home position by the drive gear. The release cam is configured for lost-motion movement with the pawl release lever after the pawl release lever reaches the pawl release position, thereby preventing unwanted over-travel of the pawl release lever and negating the need for a hard stop feature to stop movement of the pawl beyond the desired ratchet releasing position, which ultimately results in a quiet, reduced noise operation of power latch assembly.

According to another aspect of the present disclosure, a method of constructing a power latch assembly for a vehicle door is provided. The method includes configuring a ratchet for movement between a striker capture position and a striker release position and being biased toward said striker release position. Configuring a pawl for movement between a ratchet holding position, whereat the pawl maintains the ratchet in the striker capture position, and a ratchet releasing position, whereat the pawl releases the ratchet for movement of the ratchet to the striker release position. Configuring a pawl release lever for movement between a home position and a pawl release position to selectively move the pawl from the ratchet holding position to the ratchet releasing position. Configuring a power release actuator to be energized to move the pawl release lever between the home position and the pawl release position to move the pawl from the ratchet holding position to the ratchet releasing position. Configuring the power release actuator to be de-energized when the pawl release lever reaches the pawl release position to stop the pawl at the ratchet releasing position without use of a hard, positive stop.

According to another aspect of the present disclosure, the method can further include configuring an activation/deactivation device in operable communication with the pawl release lever and configuring the activation/deactivation device to allow the power release device to be energized while the pawl release lever is in the home position and to cause the power release device to be de-energized in response to the pawl being moved to the ratchet releasing position.

According to another aspect of the present disclosure, the method can further include providing the activation/deactivation device as a switch having a closed position while the pawl release lever is in the home position, whereat the power release device can be energized, and an open position while the pawl release lever is in the pawl release position, whereat the power release device is de-energized.

According to another aspect of the present disclosure, the method can further include providing the activation/deactivation device as a proximity sensor configured to detect when the pawl release lever is in the home position, whereat the power release device can be energized, and when the pawl release lever is in the pawl release position, whereat the power release device is de-energized.

According to another aspect of the present disclosure, the method can further include configuring an electronic control unit in operable communication with the proximity sensor and the power operated actuator and configuring the ECU to receive a signal from the proximity sensor indicating the pawl release lever is in its pawl release position and to send a signal to the power release actuator to reverse the direction of movement of the power release actuator in response to the pawl release lever being in its pawl release position, thereby allowing the pawl release lever to return to its home position.

According to another aspect of the present disclosure, the method can further include providing a drive gear to be driven by the power release actuator and configuring the drive gear in operable driving engagement with a driven gear having a release cam fixed thereto, and configuring the release cam to engage a cam driving surface of the pawl release lever to move the pawl release lever from the home position to the pawl release position in response to the driven gear being driven by the drive gear, and configuring the release cam for lost-motion movement with the pawl release lever after the pawl release lever reaches the pawl release position and while the driven gear is moving relative to the pawl release lever.

According to another aspect of the present disclosure, a power latch assembly for a vehicle door, including a ratchet configured for movement between a striker capture position and a striker release position and being biased toward the striker release position, a pawl configured for movement between a ratchet holding position, whereat the pawl maintains the ratchet in the striker capture position, and a ratchet releasing position, whereat the pawl releases the ratchet for movement of the ratchet to the striker release position, a power release actuator operably coupled to the pawl to move the pawl from the ratchet holding position to the ratchet releasing position, and an activation/deactivation device configured in operable communication with the power release actuator, the activation/deactivation device being in an activated state while power release actuator is in a reset position, whereat the power release actuator can be selectively energized, the activation/deactivation device being changed from the activated state to a deactivated state in response to the power release actuator shifting from the reset position to a release position, where the pawl is moved to the ratchet releasing position, whereat the power release actuator is automatically de-energized, is provided. In a related aspect, when the power release actuator is automatically de-energized, the power release actuator is not in a stall condition. In a related aspect, when the power release actuator is automatically de-energized, the power release actuator is displaced from a hard stop, or displaced from contact with a hardstop. In a related aspect, when the power release actuator is automatically de-energized, the power release actuator inertia is dissipated before the power release actuator motion is ceased by contact of the power release actuator with a hard stop.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly embodying the teachings of the present disclosure;

FIG. 2 is a perspective view of a power latch assembly embodying the teachings of the present disclosure shown schematically in operable communication with various components of the side door, with some components removed for clarity purposes only;

FIG. 3 is a perspective view of another power latch assembly embodying the teachings of the present disclosure with a pawl of the power latch assembly shown in a ratchet holding position;

FIG. 3A is a schematic side view of the power latch assembly as shown in FIG. 3 with various components removed for clarity purposes only;

FIG. 4A is a perspective view of the power latch assembly of FIG. 3 shown in an initial stage of actuation with various components removed for clarity purposes only;

FIG. 4B is a schematic side view of the power latch assembly as shown in FIG. 4A;

FIG. 5 is a perspective view of the power latch assembly of FIG. 3 shown in a final stage of actuation with the pawl be moved to a ratchet release position;

FIG. 5A is another perspective view of the power latch assembly of FIG. 3 shown in a final stage of actuation with the pawl be moved to a ratchet release position with various components removed for clarity purposes only;

FIG. 5B is a schematic side view of the power latch assembly as shown in FIGS. 5 and 5A;

FIG. 6 is a schematic side view of the power latch assembly similar to FIG. 5A showing a cam driven to an over-ride position along a pawl release lever;

FIG. 7 is a perspective view of the power latch assembly of FIG. 3 shown in an initial stage of a reset operation;

FIG. 7A is a view similar to FIG. 7 looking from a different perspective;

FIG. 7B is a schematic side view of the power latch assembly as shown in FIG. 7A; and

FIG. 8 is a method of constructing a power latch assembly in accordance with another illustrative aspect.

Corresponding reference numerals are used throughout all of the drawings to indicate corresponding parts.

### DETAILED DESCRIPTION OF EXAMPLE EMBODIMENTS

One or more example embodiments of a latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

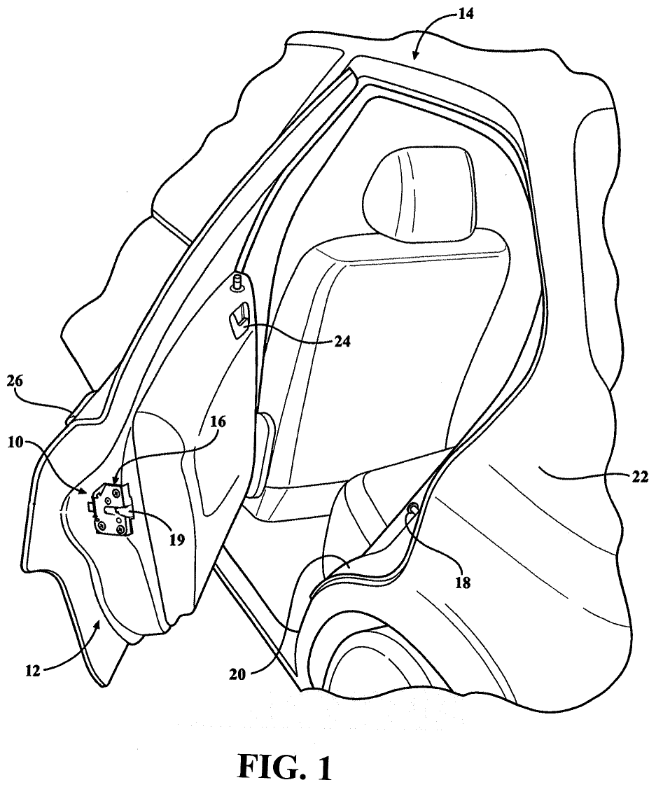

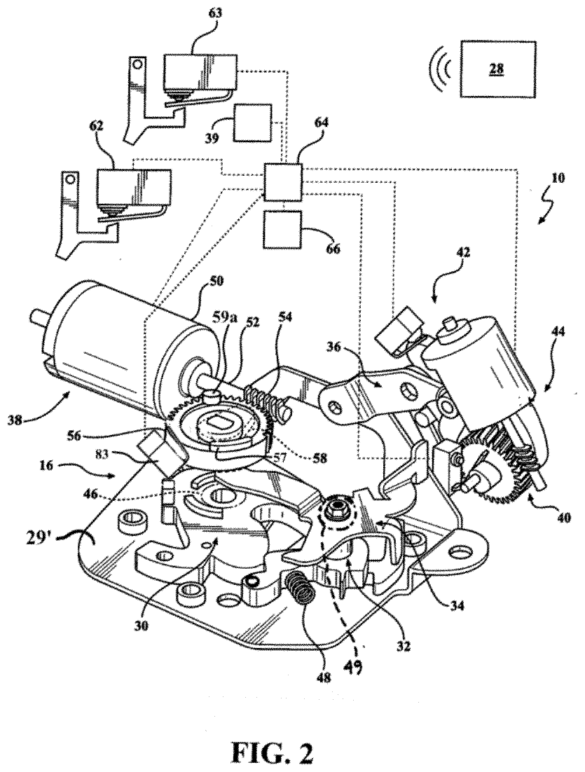

Referring initially to FIG. 1, a non-limiting example of a power latch assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 configured to releasably latch and hold a striker 18 mounted to a sill portion 20 of a vehicle body 22 when swing door 12 is closed. Latch assembly 10 can be selectively actuated via an inside door handle 24, an outside door handle 26, and a key fob 28 (FIG. 2). As will be detailed, latch assembly 10 is configured to be power-operated in a normal use state and under normal conditions, with inside door handle 24 remaining mechanically disengaged while in a child lock state and outside door handle 26 remaining mechanically disengaged during normal use conditions, such that the inside door handle 24 and outside door handle 26 are normally ineffective for mechanical actuation of latch mechanism 16 during a child lock state and while in normal use. However, the inside door handle 24 can be selectively mechanically coupled within latch mechanism 16, such as via selective actuation by a vehicle driver or occupant having access to an actuation device (not shown), e.g. button in proximity to the vehicle driver, as may be desired to override the child lock state of a rear passenger door, by way of example and without limitation, and outside door handle 26 can be configure to be automatically mechanically coupled with latch mechanism 16 in a crash condition via a mechanical override release system (not shown), such that latch mechanism 16 can be manually and mechanically actuated via inside door handle 24 and outside door handle 26, when desired, and thereafter, inside door handle 24 and outside door handle 26 can be selectively and automatically returned to their respective normal use positions, as discussed in further detail below.

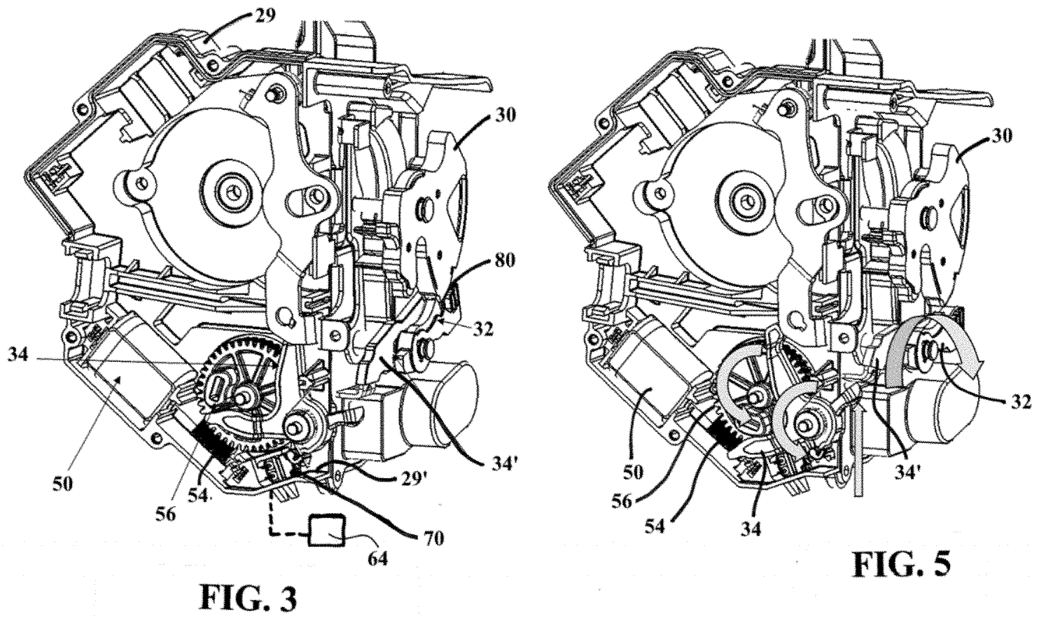

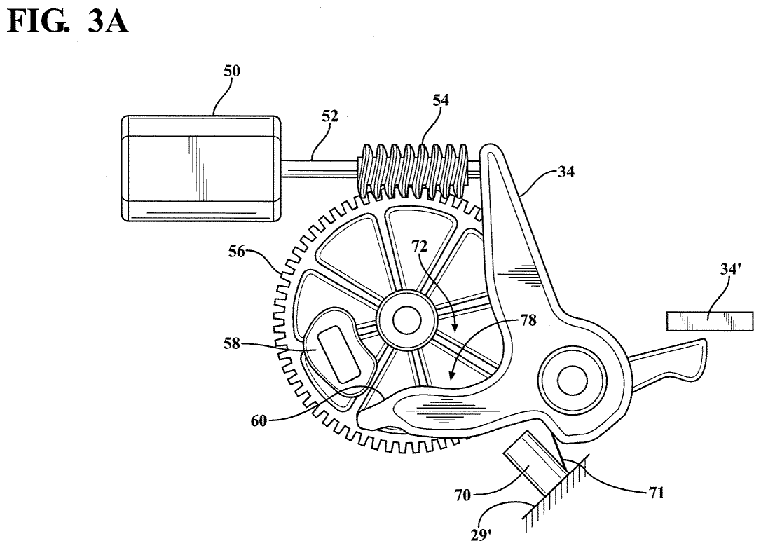

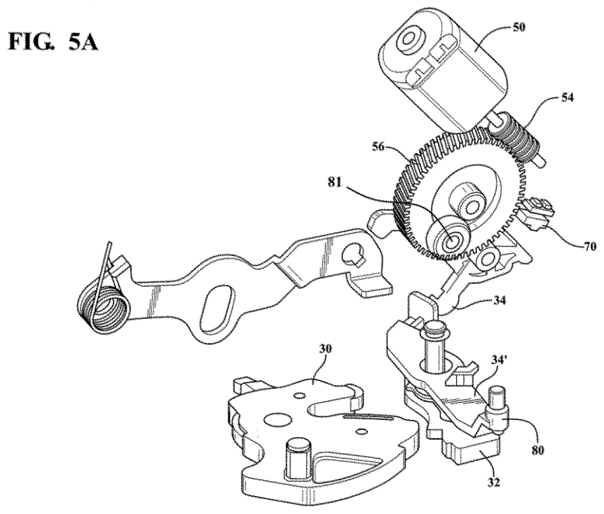

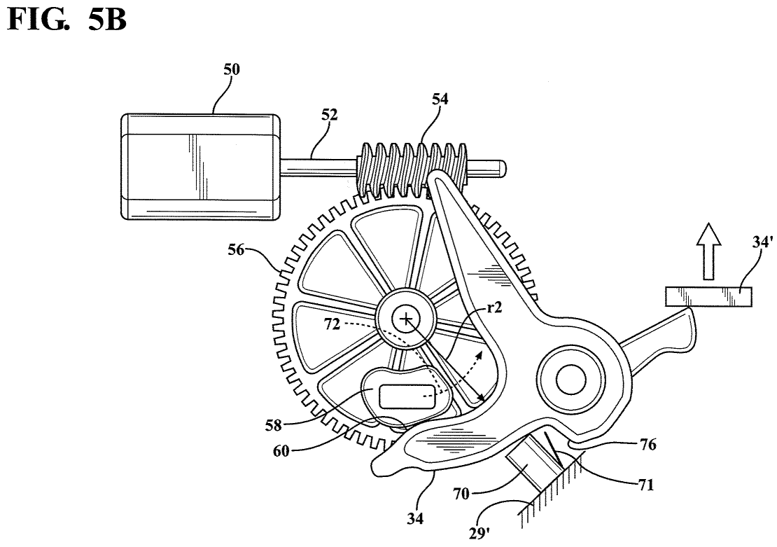

Referring to FIG. 2, shown is a non-limiting embodiment of latch assembly 10 and latch mechanism 16 contained in a housing 29, with some components removed for clarity purposes, having a ratchet 30 and a pawl 32, a latch release mechanism having a release lever, also referred to as primary pawl release lever or simply pawl release lever 34, an inside door release mechanism and an outside door release mechanism having a common inside/outside release lever, referred to hereafter simply as release lever 36, by way of example and without limitation, operably connected to inside door handle 24 and outside door handle 26 for selective mechanical operation, a power release actuator system 38 for controlling powered actuation of the latch mechanism 16, and a power lock actuator 40 having a lock mechanism 42 and an electric lock motor 44. Ratchet 30 is movable between a striker capture position (shown in FIGS. 2 and 3) whereat ratchet 30 retains striker 18 and swing door 12 in closed position, and a striker release position (FIGS. 1 and 5) whereat ratchet 30 permits release of striker 18 from a fishmouth 19 provided by a latch housing of latch assembly 10 to allow movement of swing door 12 to the open position. A ratchet biasing member 46, such as a spring, is provided to normally bias ratchet 30 toward its striker release position. Pawl 32 is movable between a ratchet holding position whereat pawl 32 holds ratchet 30 in its striker capture position, and a ratchet releasing position whereat pawl 32 permits ratchet 30 to move to its striker release position. A pawl biasing member 48, such as a suitable spring, is provided to normally bias pawl 32 toward its ratchet holding position.

Pawl release lever 34 is operatively (directly or indirectly via another component, such as an intermediate or secondary pawl release lever, and shown as directly, by way of example and without limitation) connected to pawl 32 and is movable between a deployed position, also referred to as pawl release position, whereat pawl release lever 34 moves pawl 32 to its ratchet releasing position, and a non-deployed position, also referred to as home position, whereat pawl release lever 34 permits pawl 32 to be in its ratchet holding position. A release lever biasing member 49, such as a suitable spring, can be provided to normally bias pawl release lever 34 toward its home position.

Pawl release lever 34 can be moved to its pawl release position by several components, such as, for example, by power release actuator system 38, by release lever 36. Power release actuator system 38 includes a first motor, also referred to as first actuator or power release motor 50, having an output shaft 52, with a drive gear, also referred to as power release gear, shown as a power release worm gear 54 mounted on output shaft 52, by way of example and without limitation, and a driven gear, also referred to as power release gear 56. Power release worm gear 54 is configured for operable driving engagement with power release gear 56, and can be configured in direct meshed engagement with power release gear 56, if desired. A power release cam, referred to hereafter as cam 58, is connected in fixed relation for conjoint rotation with power release gear 56 and is rotatable between a pawl release range of positions and a pawl non-release range of positions. In FIG. 2, cam 58 is located in a position that is within the pawl non-release range, while in FIG. 5B, cam 58 is located in a position that is within the pawl release range, as will be recognized by a person possessing ordinary skill in the art. Power release gear 56 is operably driven by power release worm gear 54 for driving cam 58 which, in turn, drives pawl release lever 34, via engagement with a cam driving surface 60 of pawl release lever 34, from its home position into its pawl release position.

Power release actuator system 38 can be used as part of a conventional passive keyless entry feature. When a person approaches vehicle 14 with electronic key fob 28 (FIG. 2) and actuates the outside door handle 26, for example, sensing both the presence of key fob 28 and that outside door handle 26 has been actuated (e.g. via electronic communication between an electronic switch 62 (FIG. 2, wherein inside door handle 24 also is actuatable via an electronic switch 63) and a latch electronic control unit (ECU) shown at 64 that at least partially controls the operation of latch assembly 10). In turn, latch ECU 64 actuates power release actuator system 38 to cause the power release motor 50 to act on pawl release lever 34 to release the latch mechanism 16 and shift latch assembly 10 into an unlatched operating state so as to facilitate subsequent opening of vehicle swing door 12. Power release actuator system 38 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 10). In turn, if detecting a normal use condition, such as the presence of electronic key fob 28, by way of example and without limitation, latch ECU 64 actuates power release motor 50 of power release actuator system 38 to release the latch mechanism 16 and shift latch assembly 10 into an unlatched operating state so as to facilitate subsequent opening of vehicle door 12, as discussed above.

To facilitate noise reduction of latch assembly 10 during release and reset operations, and to enhance optimal functionality of latch assembly 10, including repeatable, reliable and accurate performance and positioning of components of latch assembly between repeated use, including precisely controlling the position of driven gear 56, which is ultimately responsible for driving pawl release lever 34, which in turn is ultimately responsible for movement of pawl 32 from its ratchet holding position to its ratchet releasing position, an activation/deactivation device having activated and deactivated states, wherein activation/deactivation device can include a sensor or switch 70, by way of example and without limitation, configured to be triggered or moved between a closed position corresponding to the activated state and an open position corresponding to the deactivated state, is configured in operable communication with the pawl release lever 34 to selectively and desirably regulate power supply to the power release actuator 50. By regulating the power supply to power release actuator 50, driven gear 56 is only rotated when desired, with unwanted over-travel or under-travel thereof being minimized or negated. To further facilitate noise reduction and optimal functionality of latch assembly 10, including repeatable, reliable and accurate performance and positioning of components of latch assembly, including precisely controlling the position of driven gear 56, cam 58 and pawl release lever 34 are configured to produce only intended, desired movement of pawl release lever 34, a lost-motion connection mechanism 72 between cam 58 and pawl release lever 34 is provided. The lost-motion connection mechanism 72 limits the range of movement of pawl 32, such that pawl 32 does not move beyond its intended ratchet release position, and thus, a hard stop feature is not needed to stop the travel of pawl 32, thereby eliminating a potential source of noise. Lost-motion connection 72 allows relative movement between cam 58 and pawl release lever 34 upon pawl release lever 34 reaching its pawl release position and pawl 32 reaching its ratchet release position, such that cam 58 can continue to move rotatably to an over-travel position 74, while pawl release lever 34 remains stationary or substantially stationary (meaning pawl release lever 34 does not move nearly to the extent as release cam 58, such that pawl release lever 34 may move about 1 degree for every 10 degrees of movement of release cam 58) upon pawl release lever 34 moving to the pawl release position and bringing pawl 32 to the ratchet release position. As such, pawl release lever 34 and pawl 32 do not require nor benefit from a hard stop feature, thus, eliminating noise that would otherwise result from impact with a hard stop feature.

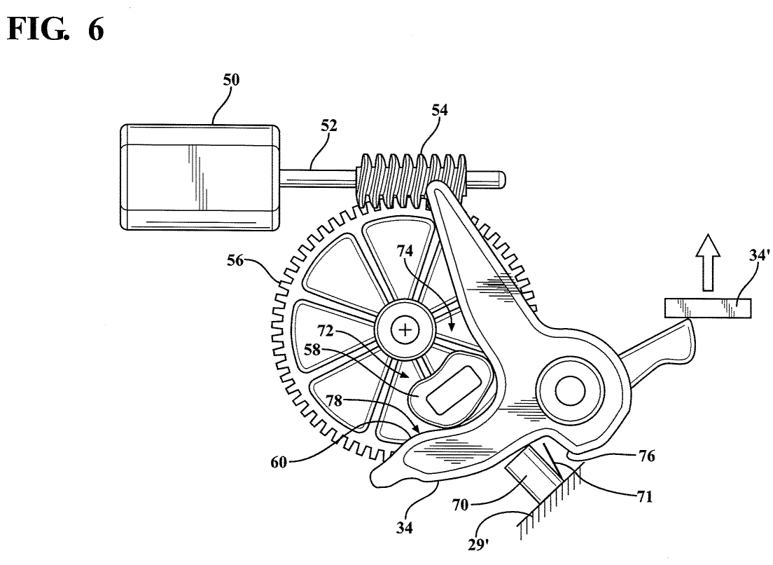

Lost-motion connection 72 is established via release cam 58 moving out of engagement with cam driving surface 60 and moving along a lost-motion cam surface 78 of pawl release lever 34. Release cam 58 is configured to travel along a constant first radii of curvature r1 relative to a rotational axis A of the driven gear 56 in response to movement of the driven gear 56. Lost-motion cam surface 78 extends from cam driving surface 60 and has a second radii of curvature r2 relative to the rotation axis A. The first radii of curvature r1 along which an outermost surface of release cam 58 travels is the same or substantially the same as the second radii of curvature r2 of lost-motion cam surface 78. Thus, as release cam 58 moves along lost-motion cam surface 78 (FIGS. 5B and 6), release cam 58 moves relative to the pawl release lever 34 along the lost-motion cam surface 78, with pawl release lever 34 remaining stationary or substantially stationary in the pawl release position.

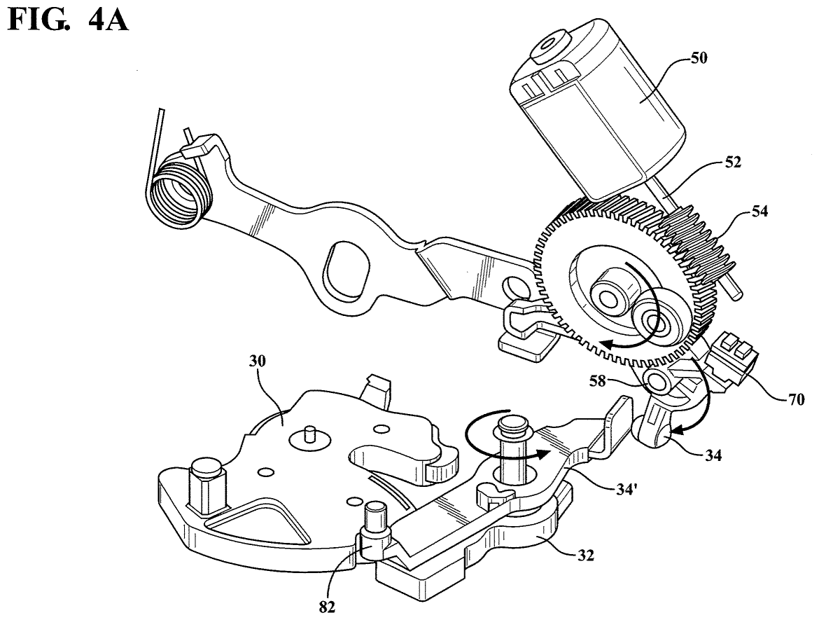

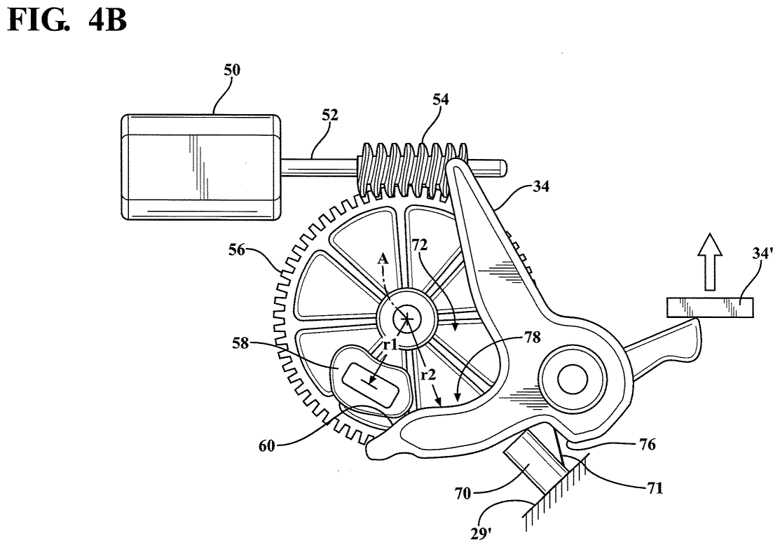

In the embodiment illustrated in FIGS. 3-7A, a secondary pawl release lever 34′ is disposed between pawl release lever 34 and pawl 32, with secondary pawl release lever 34′ being in direct engagement with pawl release lever 34 and pawl 32, thereby transferring motion of pawl release lever 34 to pawl 32 to move pawl 32 between the ratchet holding position and the ratchet releasing position, as will be understood by one possessing ordinary skill in the art. Accordingly, movement of pawl release lever 34 causes concurrent movement of secondary pawl release lever 34′.

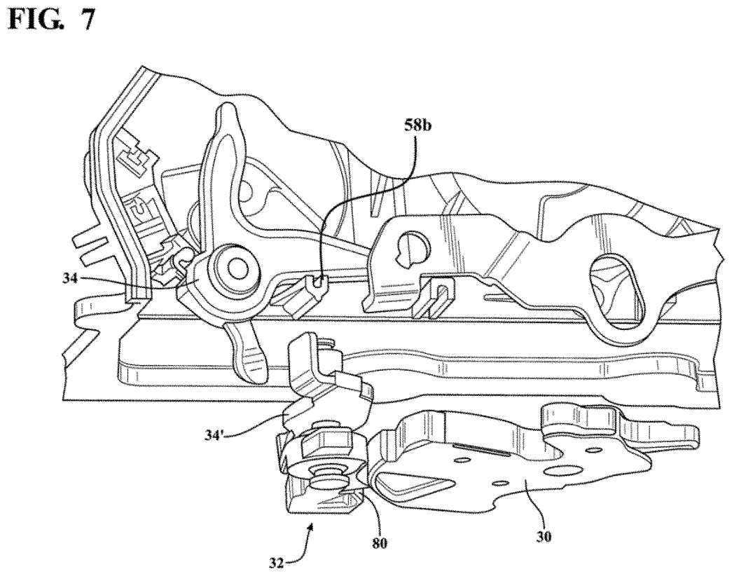

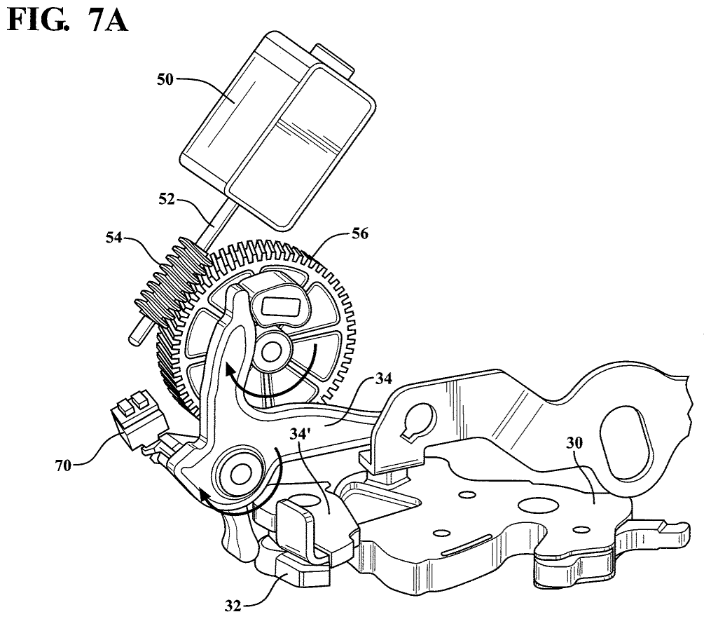

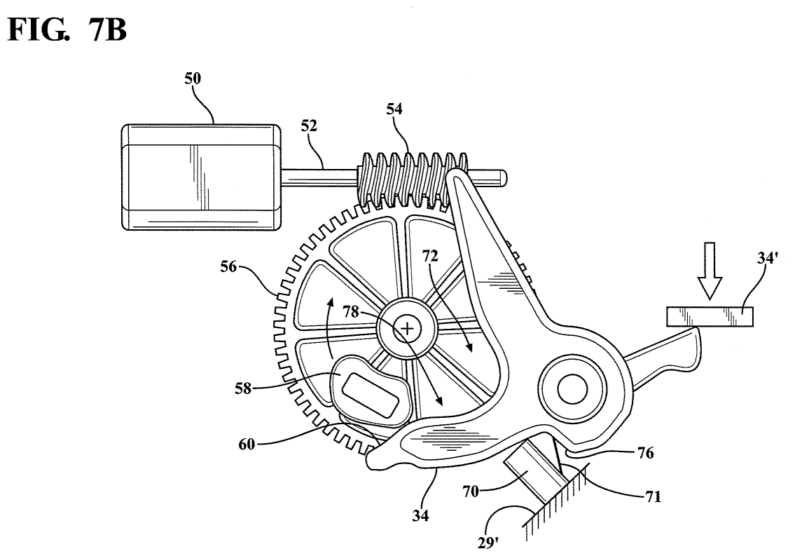

Switch 70 is shown being fixed, such as to a surface 29′ of housing 29, by way of example and without limitation. Switch 70 is positioned relative to pawl release lever 34 so that the switch 70 is maintained in the closed position (activated state) by a lug 76 of pawl release lever 34 being brought into triggering engagement or triggering close proximity with switch 70 while the pawl release lever 34 is in its home position (FIG. 3), whereat power release actuator 50 can be selectively energized. Switch 70 is also positioned so that the switch 70 is moved to an open position (deactivated state) in response to the movement of lug 76 of pawl release lever 34 out of triggering engagement or out of triggering close proximity from switch 70, with secondary pawl release lever 34′, if included, being moving by pawl release lever 34 to the pawl release position (FIGS. 5 and 5A), whereat the power release actuator 50 is automatically and temporarily de-energized in response to the switch 70 being opened when the power release actuator 50 is in the release position. As shown in FIG. 5B, when the sensor, or switch 70, has detected the power release actuator 50 releasing in the release state or position, the motor 50 is not in a stall condition, or in other words the motor 50 is not being operated to force part of the release chain such as the gear 56 against a hard stop without movement of the gear 56. Rather, motor 50 is caused to be deactivated and continued rotation of the gear 56 is possible due to the reduction of the inertia in the power release actuator 50 to be expended without a hard abutting contact with a stop surface. As shown in FIG. 5B, the lug 58 is displaced from an intermediary hard stop surface shown illustratively as one of the extending arms of pawl release lever 34, the hard stop 58b provided on the latch housing illustratively shown as acting on lug 58 through pawl release lever 34 as shown in FIG. 7. In another possible configuration a hard stop configuration may be configured as another extending lug on the opposite side of gear, for example as shown in FIG. 2 as lug 57 which may contact or activate switch 83 during releasing position of gear 56, but which may contact hard stop 59a, which may extend from the latch housing, in the event the inertia of the power actuator 50 e.g. the gear 56 is not completely diminished before the lug 57 contacts hard stop 59 upon a certain continued angular rotation of gear 56. Other configurations of a hard stop for power actuator 50 are possible. Hard stop configurations may be optionally provided as a backup in the event of a malfunction of sensor 70, 81, 83 for example. Accordingly, travel of pawl release lever 34 is stopped at the pawl release position, other than a few degrees of possible over-travel caused by inertia. It is contemplate herein that activation/deactivation device 70 can be provided via any desired type of binary switch having “on” and “off” positions, corresponding to the closed and open positions, respectively, and sensor having an activated state to indicate the pawl release lever 34 being in the closed position and a deactivated state to indicate the pawl release lever 34 being in the open position. Such switches can include a limit switch, such as including a lever 71, which can be triggered for movement between closed and open positions, a push button switch, a rotary switch, and the like. Such sensors can include a proximity sensor configured to be triggered by sensing a close proximity of lug 76, wherein detection can be inductive, capacitive, photoelectric or otherwise. Accordingly, lug 76 is configured to trigger activation/deactivation device 70 to change between the closed and open positions in response to the pawl release lever 34 being in the home and pawl release positions, respectively.

To further facilitate operation of latch assembly 10 without need of hard stop features, a magnet 80 as illustrated in FIG. 5A can be fixed to the pawl 32 and a sensor 82 can be configured in operable communication with magnet 80 to detect when the pawl 32 is in the ratchet releasing position, such that magnet 80 and sensor 82 cooperate with one another as a type of proximity sensor, wherein other types of proximity sensors are contemplated herein. The sensor 82 is configured in operable communication with the power release actuator 50, such as via ECU 64, to automatically reverse the direction of movement of the power release actuator 50 after detecting the pawl 32 being in the ratchet release position, thereby allowing the pawl release lever 34 to return to the home position. In another possible configuration the position or state of the power actuator 50 may be determined by sensing the position of the gear 56 sensed directly, rather than sensing a position of pawl release lever 34, such as by providing a hall sensor magnet 81 integrated with the gear 56 (extending from a face of the gear 56 for example) such that the magnetic field of magnet 81 when the power actuator 50 is in the releasing position is detected by a hall sensor (not shown) positioned adjacent the gear 56 and the magnetic field of the magnet remains within a detection range of the hall sensor and is further detected as the gear 56 moves past the initial releasing position due to the inertia present subsequently to de-energizing the motor 50 when the magnetic field of magnet 81 is first detected. In another possible configuration, the position of the gear 56 may be sensed directly such as by providing a sensor such as a switch 83 for sensing a position of lug 57 integrated with the gear 56 such that when the power actuator 50 is in the releasing position the switch 83 is activated or de-activated when gear 56 is in the release position and the switch 83 is continued to be activated or de-activated as the gear 56 moves past the initial releasing position due to the inertia subsequently to de-energizing the motor 50 when the switch 83 detects the gear 56 in the release position. As seen in FIG. 2 switch 83 would be configured for continuous activation after gear 56 has been rotated clockwise and continues to rotate due to inertia when the motor 50 has been stopped in response to the detected activation of switch 83. As pawl release lever 34 returns toward the home position, lug 76 returns into engagement with the switch 70 to move the switch 70 to the closed position. Driven gear 56 returns to the driven gear home position during reverse movement of power release actuator 50 without use of a hard stop and without use of a sensor to detect the position of the driven gear 56. It is to be understood that activation/deactivation device 70 can configured in operable communication with the power release actuator 50, such as via ECU 64, to automatically reverse the direction of movement of the power release actuator 50. For example, after detecting the pawl release lever 34 being in the pawl release position and/or the activation/deactivation device 70 being in its open position, the direction of movement of power release actuator 50 can be reversed, thereby allowing the pawl release lever 34 to return to its home position. When pawl release lever 34 is returned to its home position and/or the activation/deactivation device 70 is returned to its closed position, power release actuator 50 can be commanded to be de-energized in response to ECU 64 receiving a signal from activation/deactivation device 70 and ECU 64 sending a corresponding de-energization signal to power release actuator 50.

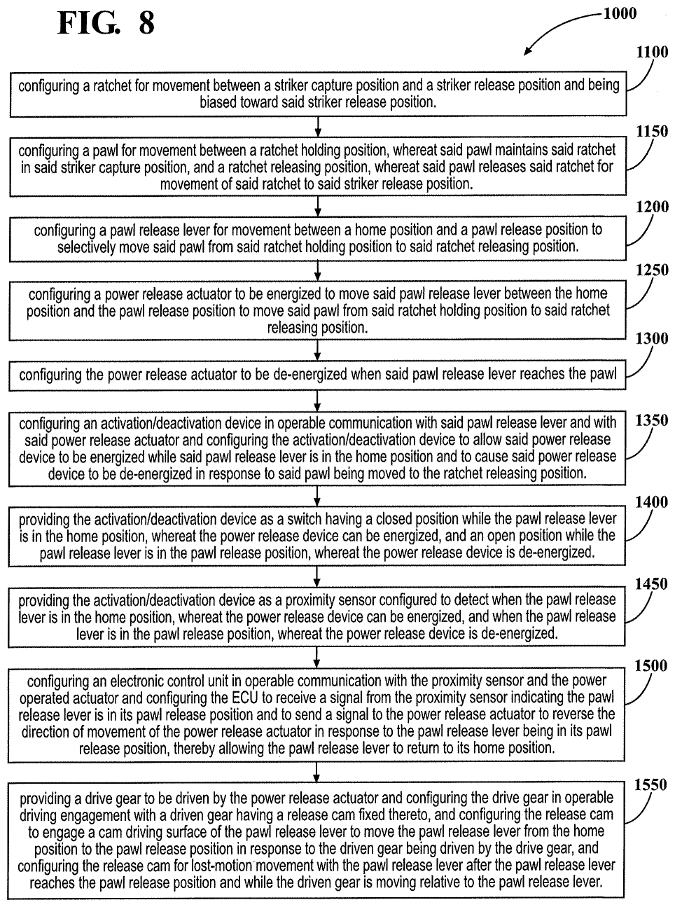

In accordance with another aspect, as shown in FIG. 8, a method 1000 of constructing a power latch assembly 10 for a vehicle door 12 is provided. The method 1000 includes a step 1100 of configuring a ratchet 30 for movement between a striker capture position and a striker release position and being biased toward said striker release position. Further, a further step 1150 incudes configuring a pawl 32 for movement between a ratchet holding position, whereat the pawl 32 maintains the ratchet 30 in the striker capture position, and a ratchet releasing position, whereat the pawl 32 releases the ratchet 30 for movement of the ratchet 30 to the striker release position. A further step 1200 includes configuring a pawl release lever 34 for movement between a home position and a pawl release position to selectively move the pawl 32 from the ratchet holding position to the ratchet releasing position. A further step 1250 includes configuring a power release actuator 50 to move the pawl release lever 34 between the home position and the pawl release position to move the pawl 32 from the ratchet holding position to the ratchet releasing position. And, a further step 1300 includes configuring the power release actuator 50 to be de-energized when the pawl release lever 34 reaches the pawl release position to stop the pawl 32 at the ratchet releasing position without use of a hard, positive stop.

According to another aspect of the present disclosure, the method can further include a step 1350 of configuring an activation/deactivation device in operable communication with the pawl release lever and configuring the activation/deactivation device to allow the power release device to be energized while the pawl release lever is in the home position and to cause the power release device to be de-energized in response to the pawl being moved to the ratchet releasing position.

According to another aspect of the present disclosure, the method can further include a step 1400 of providing the activation/deactivation device as a switch having a closed position while the pawl release lever is in the home position, whereat the power release device can be energized, and an open position while the pawl release lever is in the pawl release position, whereat the power release device is de-energized.

According to another aspect of the present disclosure, the method can further include a step 1450 of providing the activation/deactivation device as a proximity sensor configured to detect when the pawl release lever is in the home position, whereat the power release device can be energized, and when the pawl release lever is in the pawl release position, whereat the power release device is de-energized.

According to another aspect of the present disclosure, the method can further include a step 1500 of configuring an electronic control unit in operable communication with the proximity sensor and the power operated actuator and configuring the ECU to receive a signal from the proximity sensor indicating the pawl release lever is in its pawl release position and to send a signal to the power release actuator to reverse the direction of movement of the power release actuator in response to the pawl release lever being in its pawl release position, thereby allowing the pawl release lever to return to its home position.

According to another aspect of the present disclosure, the method can further include a step 1550 of providing a drive gear to be driven by the power release actuator and configuring the drive gear in operable driving engagement with a driven gear having a release cam fixed thereto, and configuring the release cam to engage a cam driving surface of the pawl release lever to move the pawl release lever from the home position to the pawl release position in response to the driven gear being driven by the drive gear, and configuring the release cam for lost-motion movement with the pawl release lever after the pawl release lever reaches the pawl release position and while the driven gear is moving relative to the pawl release lever.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a vehicle door, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a pawl release lever configured for movement between a home position and a pawl release position to selectively move said pawl from said ratchet holding position to said ratchet releasing position;
a power release actuator configured to move said pawl release lever between the home position and the pawl release position to move said pawl from said ratchet holding position to said ratchet releasing position; and
an activation/deactivation device configured in operable communication with said pawl release lever, said activation/deactivation device being in an activated state while said pawl release lever is in the home position, whereat said power release actuator can be selectively energized, said activation/deactivation device being changed from the activated state to a deactivated state in response to said pawl being moved to the ratchet releasing position, whereat said power release actuator is automatically de-energized.

2. The power latch assembly of claim 1, further including a drive gear driven by said power release actuator, said drive gear being in operable driving engagement with a driven gear having a release cam fixed thereto, said release cam being configured to engage a cam driving surface of said pawl release lever to move said pawl release lever between the home position and the pawl release position in response to said driven gear being driven from a driven gear home position by said drive gear, said release cam being configured for lost-motion movement with said pawl release lever after said pawl release lever reaches the pawl release position.

3. The power latch assembly of claim 2, wherein said release cam travels along a first radii of curvature relative to a rotational axis of said driven gear in response to movement of said driven gear, said pawl release lever having a lost-motion cam surface extending from said cam driving surface, said lost-motion cam surface having a second radii of curvature relative to said rotation axis, said first radii of curvature being substantially the same as said second radii of curvature such that said release cam moves relative to said pawl release lever along said lost-motion cam surface.

4. The power latch assembly of claim 3, wherein said pawl release lever remains stationary as said release cam moves along said lost-motion cam surface, thereby preventing said pawl release lever from moving beyond the pawl release position.

5. The power latch assembly of claim 1, wherein said activation/deactivation device remains in the deactivated state when said pawl release lever is in the pawl release position.

6. The power latch assembly of claim 1, wherein said pawl release lever has a lug configured to trigger said activation/deactivation device to change said activation/deactivation device between the activated and deactivated states.

7. The power latch assembly of claim 6, wherein said lug moves into engagement with said activation/deactivation device to move said activation/deactivation device to the activated state when said pawl release lever returns toward the home position.

8. The power latch assembly of claim 1, further including a magnet fixed to said pawl and a sensor configured in operable communication with said magnet to detect when said pawl is in said ratchet releasing position, said sensor being configured in operable communication with said power release actuator to automatically reverse the direction of movement of said power release actuator after detecting said pawl being in the ratchet release position to allow the pawl release lever to return to the home position.

9. The power latch assembly of claim 2, wherein said driven gear returns to the driven gear home position without use of a hard stop.

10. The power latch assembly of claim 9, wherein said driven gear returns to the driven gear home position without use of a sensor detecting the position of said driven gear.

11. A power latch assembly for a vehicle door, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a pawl release lever configured for movement between a home position and a pawl release position to selectively move said pawl from said ratchet holding position to said ratchet releasing position;
a power release actuator configured to move said pawl release lever between the home position and the pawl release position to move said pawl from said ratchet holding position to said ratchet releasing position; and
a drive gear driven by said power release actuator, said drive gear being in operable driving engagement with a driven gear having a release cam fixed thereto, said release cam being configured to engage a cam driving surface of said pawl release lever to move said pawl release lever between the home position and the pawl release position in response to said driven gear being driven from a driven gear home position by said drive gear, said release cam being configured for lost-motion movement with said pawl release lever after said pawl release lever reaches the pawl release position.

12. The power latch assembly of claim 11, further including a switch configured in operable communication with said pawl release lever, said switch being in a closed position while said pawl release lever is in the home position, whereat said power release actuator can be selectively energized, said switch being moved to an open position in response to said pawl being moved to the ratchet releasing position, whereat said power release actuator is automatically de-energized.

13. The power latch assembly of claim 12, wherein said pawl release lever has a lug configured to engage said switch to bring said switch to the closed position and to move out of engagement with said switch to bring said switch to the open position.

14. The power latch assembly of claim 13, wherein said lug returns into engagement with said switch to move said switch to the closed position as said pawl release lever returns toward the home position.

15. A method of constructing a power latch assembly for a vehicle door, comprising:
a step of configuring a ratchet for movement between a striker capture position and a striker release position and being biased toward said striker release position;
a step of configuring a pawl for movement between a ratchet holding position, whereat said pawl maintains said ratchet in said striker capture position, and a ratchet releasing position, whereat said pawl releases said ratchet for movement of said ratchet to said striker release position;
a step of configuring a pawl release lever for movement between a home position and a pawl release position to selectively move said pawl from said ratchet holding position to said ratchet releasing position;
a step of configuring a power release actuator to be energized to move said pawl release lever between the home position and the pawl release position to move said pawl from said ratchet holding position to said ratchet releasing position; and
a step of configuring the power release actuator to be de-energized when said pawl release lever reaches the pawl release position to stop said pawl at said ratchet releasing position without use of a hard, positive stop.

16. The method of claim 15, further including a step of configuring an activation/deactivation device in operable communication with said pawl release lever and with said power release actuator and configuring the activation/deactivation device to allow said power release device to be energized while said pawl release lever is in the home position and to cause said power release device to be de-energized in response to said pawl being moved to the ratchet releasing position.

17. The method of claim 16, further including providing the activation/deactivation device as a switch having a closed position while the pawl release lever is in the home position, whereat the power release device can be energized, and an open position while the pawl release lever is in the pawl release position, whereat the power release device is de-energized.

18. The method of claim 16, further including providing the activation/deactivation device as a proximity sensor configured to detect when the pawl release lever is in the home position, whereat the power release device can be energized, and when the pawl release lever is in the pawl release position, whereat the power release device is de-energized.

19. The method of claim 18, further including a step of configuring an electronic control unit in operable communication with the proximity sensor and the power operated actuator and configuring the ECU to receive a signal from the proximity sensor indicating the pawl release lever is in its pawl release position and to send a signal to the power release actuator to reverse the direction of movement of the power release actuator in response to the pawl release lever being in its pawl release position, thereby allowing the pawl release lever to return to its home position.

20. The method of claim 15, further including a step of providing a drive gear to be driven by the power release actuator and configuring the drive gear in operable driving engagement with a driven gear having a release cam fixed thereto, and configuring the release cam to engage a cam driving surface of the pawl release lever to move the pawl release lever from the home position to the pawl release position in response to the driven gear being driven by the drive gear, and configuring the release cam for lost-motion movement with the pawl release lever after the pawl release lever reaches the pawl release position and while the driven gear is moving relative to the pawl release lever.
